(19) United States
(12) Patent Application Publication
(10) Pub. No.: US 2014/0215333 A1
(43) Pub. Date: Jul. 31, 2014

(54) Bookmarking segment of offline content and associating bookmarks with online content

(71) Applicant: HCL Technologies Limited, Chennai (IN)

(72) Inventors: Subramanya Uma Maheswara Prasad Dhanyamraju, Hyderabad (IN); Yogesh Gupta, Noida (IN); Sivanand Lanka, Hyderabad (IN); Ramaraju Venkata Subramanya Sekhar, Hyderabad (IN)

(21) Appl. No.: 13/945,852

(22) Filed: Jul. 18, 2013

(30) Foreign Application Priority Data
Jan. 30, 2013 (IN) 420/CHE/2013

(51) Int. Cl. G06F 3/01

(52) U.S. Cl. CPC G06F 3/01
USPC 715/716

(57) ABSTRACT

The Embodiments provides a method for bookmarking and dynamically associating bookmarks of offline content with online content. The method includes receiving request from a user to bookmark segments of online/offline content and generating bookmarks for the segments of the content. Further, the method includes associating the bookmarks for the segments of the content bookmarked by the user and playing the segments of the content using the bookmarks.

### PRIORITY DETAILS

The present application is based on, and claims priority from, Indian Application Number 420/CHE/2013, filed on 30 Jan. 2013, the disclosure of which is hereby incorporated by reference herein.

### TECHNICAL FIELD

The embodiments herein relate to bookmarks management systems, and more particularly, to a mechanism for bookmarking and associating segments of content bookmarked online and offline by a user.

### BACKGROUND OF EMBODIMENTS

An Internet-enabled device allows a user to browse multimedia contents, such as audio and video, using an Internet browser. The user can access, play, or view the contents using a multimedia player or any other player application in both online and offline modes. Generally, almost all the multimedia players provide functionality of adding bookmarks to audio and video contents. The user can tag their area of interested segment in the content to add the bookmark and respective metadata of the content may get updated with the bookmark name, starting location/timestamp, ending location/timestamp, and other information related to the bookmark.

Conventional methods and systems can allow the user to browse the interested bookmarks and play the content from selected bookmarked location of the player or browser application. This enables the content to be played till the end from the bookmarked location instead of playing the interested segment of the content. Further, the conventional methods and systems may not perform effective synchronization and/or association of the content segments bookmarked online and offline by the user.

Though the existing systems and methods are effective to a degree in managing bookmarks of the segments of content but include both advantages and disadvantages in terms of online bookmark segments of the content, offline bookmark segments of the content, bookmarks association, optimization, storage, usage, time, cost, and performance.

### SUMMARY OF THE EMBODIMENTS

Accordingly the Embodiments provides a method for bookmarking and dynamically associating bookmarks of offline content with online content. The method includes receiving request from a user to bookmark segment(s) of content and generating bookmarks for the segments of the content. The content described herein can be an online content or offline content. Further, the method includes associating the bookmarks for the segments of the content bookmarked by the user and playing the segments of the content using the bookmarks.

In an embodiment, the content includes audio and video content. Furthermore, the method includes storing the online content to access offline by the user and registering the user to allow access to the online and offline content. In an embodiment, the request includes starting location and ending location of the segment of the content. The bookmark includes a uniform resource locater for the segment of the content. Furthermore, the method includes maintaining a metadata associated with the content, updating the metadata upon receiving the request from the user to bookmark the segment of the content, and authenticating the user upon receiving the request to bookmark the segment of the content. Furthermore, the method includes sharing the bookmarks with the other user and allowing the other users to play the segment of the content using the bookmarks.

Accordingly the Embodiments provides a system for bookmarking and dynamically associating bookmarks of offline content with online content. The system includes a media server configured to receive the request from a user to bookmark segment(s) of content and generate bookmarks for the segments of the content. The content described herein can be an online content or offline content. Further, the media server is configured to associate the bookmarks for the segments of the content bookmarked by the user and play the segments of the content using the bookmarks.

In an embodiment, the content includes audio and video content. Furthermore, the media server is configured to store the online content to access offline by the user and register the user to allow access to the online and offline content. In an embodiment, the request includes starting location and ending location of the segment of the content. The bookmark includes a uniform resource locater for the segment of the content. Furthermore, the media server is configured to maintain a metadata associated with the content, update the metadata upon receiving the request from the user to bookmark the segment of the content, and authenticate the user upon receiving the request to bookmark the segment of the content. Furthermore, the media server is configured to share the bookmarks with the other user and allow the other users to play the segment of the content using the bookmarks.

These and other aspects of the embodiments herein will be better understood when considered in conjunction with the following description and the accompanying drawings. It should be understood, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

The embodiments herein will be better understood from the following detailed description with reference to the drawings, in which:

FIG. 1 is a block diagram illustrating generally, an exemplary video content with bookmarks, according to the embodiments disclosed herein;

FIG. 2 is a block diagram illustrating generally, among other things, a system to implement bookmarking segments of content, according to the embodiments disclosed herein;

FIG. 3 is a block diagram illustrating generally, operations performed to add bookmark to a segment of an online content by the system as described in the FIG. 2, according to the embodiments disclosed herein;

FIG. 4 is a block diagram illustrating generally, operations performed to play bookmarked segment of the online content by the system as described in the FIG. 2, according to the embodiments disclosed herein;

FIG. 5 is a block diagram illustrating generally, operations performed to add bookmark to a segment of an offline content and associate with the online content, by the system as described in the FIG. 2, according to the embodiments disclosed herein;

FIG. 6 is a block diagram illustrating generally, operations performed to add bookmark to a segment of an online content from an exemplary digital media device, according to the embodiments disclosed herein;

FIG. 7 is a block diagram illustrating generally, operations performed to play bookmarked segment of the online content on the exemplary digital media device, according to the embodiments disclosed herein;

FIG. 8 is a block diagram illustrating generally, operations performed to add and play bookmark segment of offline content on the exemplary digital media device, according to the embodiments disclosed herein;

FIG. 9 is a flow diagram illustrating a method for implementing, associating, and sharing bookmarks for segments of online/offline contents, according to the embodiments disclosed herein; and

FIG. 10 illustrates a computing environment implementing the method and system as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system for bookmarking and dynamically associating bookmarks of offline with online content. A user can bookmark a segment (interested scene) in audio or video content playing online or offline in a multimedia player, browser, smart phone, tablet, or any other device or application. The user can view the content online and can store the content to view it offline. The user can mark a staring location/timestamp and ending location/timestamp in the content to bookmark the selected segment of the content. The content described herein can be an online multimedia content, offline multimedia content, or a combination thereof. A metadata associated with the content can be stored in the system. A respective bookmark including a uniform resource locator (URL) for each selected segment of the content can be generated and shared with one or more users over a communication network. The user(s) can directly view only the interested segment of the content using the generated bookmark. Further, the method includes associating the bookmarks of the segments of the content bookmarked by the user, during offline and online usage of the content.

The proposed system and method is simple, robust, dynamic, inexpensive, and reliable for managing bookmarks for the segments of the content accessed online and offline by a user. For example, students or any user can bookmark the relevant portion of any video, learning tutorial(s), recorded live lecture, or the like available for streaming and view or access both offline and online. Unlike the convention systems, the present Embodiments can be used to automatically associate the offline bookmarks with the online bookmarks (created by the user) for the segments of the content. The system and method enables the user to view only the selected segment of the content using the bookmarks. Further, the system and method can be used to share the bookmarks on social platform, emails, or with any other user over the communication network such that the users can directly view only the interested segment of the content.

The present Embodiments can be used to enhance the user experience by providing appropriate segments of the content (instead of the whole content) to the user for quickly trouble shooting, handling, or recovering any issues or problems. For example, corporate knowledge management portals can share video tutorials in controlled and systematic way, by sharing only required chapter(s) or sub-chapter(s) instead of sharing the whole video tutorial(s). Technical support portals can provide access to the required videos for quickly and easily troubleshooting field issues, which can further reduce the time to spend on voice calls helping the customers to resolve the issues. Technical services can improve the customer experience by providing appropriate videos to the customers to easily recover from the problem(s). Maintenance management procedures can be increased as only the required technical sub-chapters are shared with the technicians. Furthermore, the proposed system and method can be implemented on the existing infrastructure and may not require extensive set-up or instrumentation.

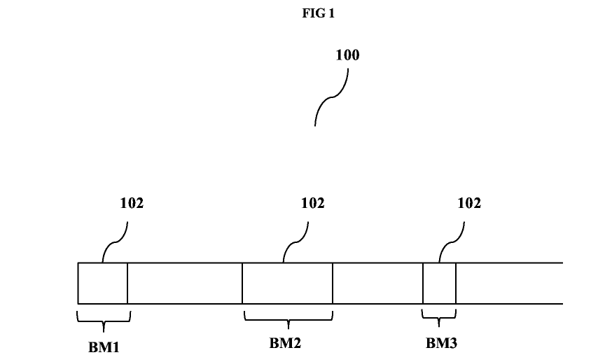

FIG. 1 is a block diagram, illustrating generally, an exemplary video content 100 with bookmarks, according to the embodiments disclosed herein. A user can view online or offline video content and can input a request to create a bookmark for a particular segment 102 of the video content 100. The user can mark a starting location/timestamp and an ending location/timestamp of that particular segment within the video content 100. The segment itself or an identifier of the segment can be saved in the bookmark. The FIG. 1 shows three bookmarks namely, BM1, BM2, and BM3 respectively, created by the user in the video content 100. Bookmarking a segment of the content allows the user to identify a particular segment of the content and can include various tags associated with that particular segment. Each bookmark can be associated with a metadata including the information related to the segment such as for example, but not limited to, the start location/timestamp of the bookmark in the video content, the end location/timestamp of the bookmark in the video content, and the like. This metadata information can be used to play the bookmark in the video content. Further, the bookmarks can be used in various manners, such as being subsequently retrieved and the corresponding segment of the content played back, being shared with other users, and so forth.

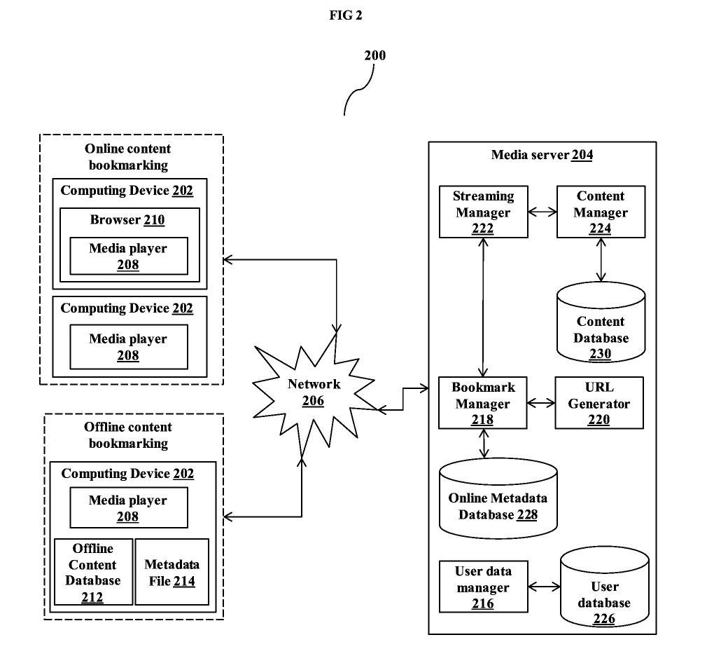

FIG. 2 is a block diagram illustrates generally, among other things, a system 200 for implementing the bookmarking segments of content, according to the embodiments disclosed herein. As shown in the FIG. 2, the system 200 can be used to bookmark and play interested segments of the online/offline content marked by the user. The system 200 can be configured to include computing device 202 configured to communicate with the media server 204 over the communication network 206. In an embodiment, the communication network 206 described herein can include for example, but not limited to, wireless communication network, wire line communication network, cellular network, global system for mobile communication, local area network, wide area network, personal area network, private area network, public network such as Internet, combination thereof, or any other communication network.

In an embodiment, the computing device 202 described herein can be a variety of different types of devices. For example, but not limited to, desktop computer, server computer, laptop, net-book computer, tablet, notepad computer, mobile station, smart phone, entertainment appliance, set-top box communicatively coupled to display device, television, cellular or other wireless phone, game console, automotive computer, and the like. In an embodiment, the computing device 202 can range from a full resource device with substantial memory and processor resources (e.g., personal computers, game consoles, and the like) to a low-resource device with limited memory and/or processing resources (e.g., traditional set-top boxes, hand-held game consoles, and the like).

In an embodiment, the user can browse or play the online/offline video thorough a media player 208 installed on the computing device 202. The media player 208 described herein can be an online player, native application, standalone application, or any other player capable of playing multimedia contents on the computing device 202. In an embodiment, the computing device 202 can be configured to allow the user to browse and access the online content using a browser 208. The content described herein can include for example, but not limited to, audio, video, combination thereof, or any other content. The browser 210 described herein can be configured to interact with the media player 208 to view and play the online content. Further, the computing device 202 can be configured to include various interfaces and communications to communicate with the media server 204 over the communication network 206. The user can access the online content and bookmark the interested segment of the content.

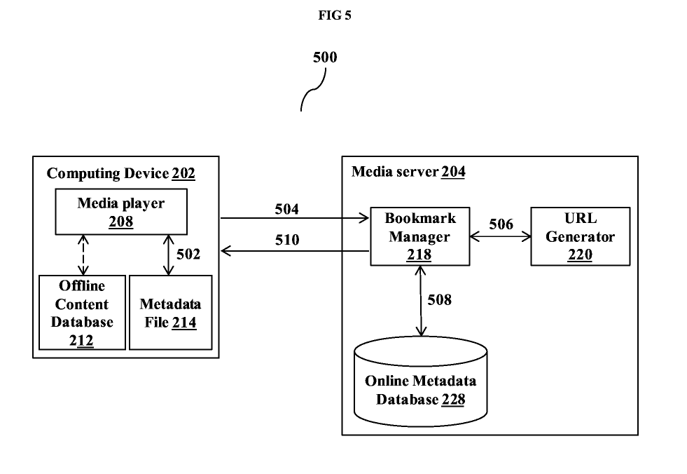

In an embodiment, the computing device 202 can be configured to allow the user to access the offline content. The online content can be stored in an offline content database 212 on the computing device 202 to access the content offline. Each online or offline content can be associated with a metadata file 214 including the information about the online/offline content. The metadata file 214 associated with the offline content can be stored in the offline content database 212. Further, operations performed by the system 200 to add and play bookmarks using the offline content is described in conjunction with FIG. 5.

In an embodiment, the media server 204 can be configured manage the bookmarks created by the user using the online content. The media server 204 can be configured to include a user data manager 216, a bookmark manager 218, a URL generator 220, a streaming manager 222, and a context manager 224.

In an embodiment, the user data manager 216 can be configured to allow the user to register with the media server 204 to access the online or offline content. The user data manager 216 can be configured to store the user registration information in the user database 226. In an embodiment, the registration information described herein can include for example, but not limited to, user name, user age, user login information such as user identifier, password, bookmark information, and other information related to the user. The media server 204 can be configured to authenticate and validate the user using the registration information stored in the user database 226, such as to allow the user to create and manage the bookmarks. In an example, upon adding or deleting a bookmark, the media server 204 in communication with the user data manager 216, authenticates the user by validating/verifying the user login information stored in the user database 226. Further, the user can be validated upon attaching or associating the offline bookmarks with the online content, creating a bookmarks using offline or online content, storing media content files on the media server 204, and the like.

In an embodiment, the bookmark manager 218 can be configured to maintain bookmarks set by the user for the content. The bookmark manager 218 can be configured to store the bookmark information in an online metadata database 228. The online metadata database 228 can be configured to include information related to the online content and associated bookmarks created by the user.

In an embodiment, the URL generator 220 can be configured to generate a URL for each segment of the online or offline content bookmarked by the user. The URL described herein can be configured to include only the segment (or portion) of the content selected by the user by using which the selected segment of the online or offline content can be directly played by the user. Further, the user can share the URL corresponding to the bookmark segments of the content with one or more other users, using different channels available for sharing such as for example, but not limited to, social media, email, websites, and the like.

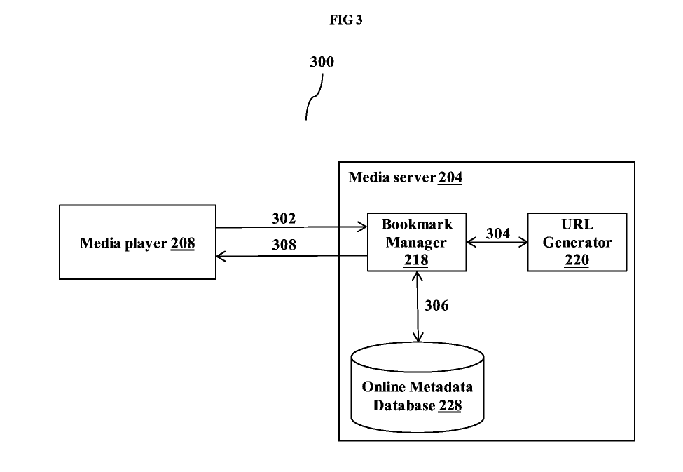

Further, the bookmark (including the URL of the selected segment) can be used to playing back the content associated with the segment and/or various tags associated with the particular segment. In an embodiment, the streaming manager 222 can be configured to provide the selected segment of the content associated with the bookmark, such as to stream the segment of the content on the media player 208 deployed on the computing device 202. In an embodiment, the content manager 224 can be configured to store the online content on the content database 230. The streaming manager 222, in communication with the content manager 224, can be configured to get only the selected segment of the content indicated for the specified time duration in the bookmark from the content database 230. Further, the streaming manager 222 can be configured to stop playing the content, when the content reaches the bookmark end location/timestamp. Further, various operations performed by the system to add, play, share, and associate bookmarks for the selected segments of the online and offline contents are described in conjunction with the FIGS. 3 through 8.

FIG. 3 is a block diagram illustrating generally, operations 300 performed to add bookmarks to a segment of an online content by the system 200 as described in the FIG. 2, according to the embodiments disclosed herein. While playing the online content (such as an audio, video, or a combination thereof) using the media player 208 (deployed on the computing device 202), the user can select an interested segment (or a portion of video) in the online content for bookmarking. In an embodiment, at 302, once the user selects the segment, the media player 208 can be configured to transfer the information related to the selected segment to the bookmark manager 218. In an example, the information related to the selected segment includes for example, but not limited to, content identifier, start location/timestamp, end location/timestamp, user name, user ID, and the like.

In an embodiment, at 304, the bookmark Manger 218 can be configured to send the information to the URL generator 220. In an example, the URL generator 220 can be configured to prepare a bookmark URL which can be understandable by streaming manager 222.

In an embodiment, at 306, the bookmark manger 218 can be configured to store the metadata data of the bookmark information and the bookmark URL into the online metadata database 228. Further, at 308, the bookmark manger 218 can be configured to return the generated bookmark URL to the media player 208.

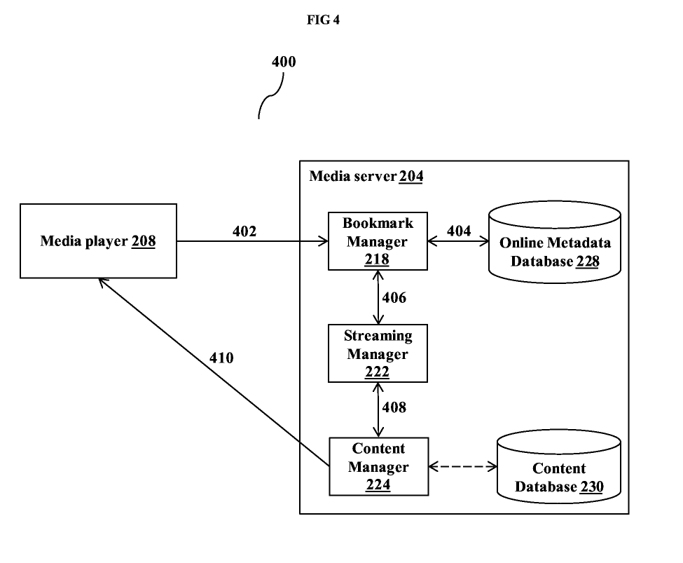

FIG. 4 is a block diagram illustrating generally, operations 400 performed to play the bookmarked segment of the online content by the system 200 as described in the FIG. 2, according to the embodiments disclosed herein. The FIG. 4 describes the operations performed to play the bookmarked segment of the online content created in the FIG. 3. In an embodiment, at 402, when the user opens online video from the media player 208 on the computing device 202 and selects a bookmark URL, the media player 208 can be configured to send the bookmark URL to the bookmark manager 218.

In an embodiment, at 404, the bookmark manager 218 can be configured to retrieve the bookmark information from the online metadata database 228. The bookmark manager 218 can be configured to include sufficient interfaces and programming instructions to generate a query and retrieve the respective bookmark information. In an embodiment, at 406, the bookmark manager 218 can be configured to send the bookmark information to the streaming manager 222.

In an embodiment, at 408, the streaming manager 222 can be configured to communicate with the content manager 224 to get the desired content from the online content database 230. In an example, the streaming manager 222 can retrieve only the selected segment of the content (instead of entire content) from the online content database 230. In an embodiment, at 410, the streaming manager 222 can be configured to stream the segment of the content on the media player 208. The streaming manager 222 can stream only the selected portion of the content starting from the start location/timestamp of bookmark to till the end location/timestamp of bookmark. For example, maintenance technicians can view or access to only required sub-chapter(s) of a video (IETMs (Interactive Electronic Technical Manuals), Operating Procedures and Installation Instructions and so on) for operations, service, repairs, maintenance or technical support, instead of viewing the whole technical video, which can further helps the technicians to quickly and efficiently accomplish the task.

FIG. 5 is a block diagram illustrating generally, operations 500 performed to add bookmark to a segment of offline content and associate with the online content, by the system 200 as described in the FIG. 2, according to the embodiments disclosed herein. In an embodiment, the user can play the content offline by storing the online content in the computing device 202. While playing the content offline, the user can select a starting location/timestamp and an end location/timestamp in the offline content, such as to bookmark the selected segment of the offline content. In an embodiment, at 502, the media player 208 can be configured to write the bookmark information to respective offline metadata file 214 associated with the offline content. Upon storing the online content on the computing device 202 for accessing it offline, the computing device 202 can also store the corresponding metadata file 214 associated with the content.

In an embodiment, at 504, when the user selects to upload all or the selected bookmarks, the media player 208 can be configured to transfer the information related to the bookmarks of the offline content to the bookmark manager 218. In an example, the information related to the bookmarks includes for example, but not limited to, bookmark metadata (including start location/timestamp and end location/timestamp of the selected segments of the offline content), content identifier, user name, user ID, and the like. The media player 208 transfers the bookmarks information to associate or attach the offline content bookmarks to the corresponding online contents.

In an embodiment, at 506, the bookmark manger 218 can be configured to send the information to the URL generator 220. In an example, the URL generator 220 can be configured to prepare a bookmark URL which can be understandable by streaming manager 222.

In an embodiment, at 508, the bookmark manger 218 can be configured to store the metadata data of the bookmark information associated with the offline content and the bookmark URL into the online metadata database 228. In an example, the bookmark manager 218 can store the generated URL in to the metadata only when the user ID of the corresponding user is provided.

In an embodiment, at 510, the bookmark manger 218 can be configured to return the generated bookmark URL(s) to the media player 208. The bookmark URL(s) returned to the media player 208 can include all the bookmarks bookmarked by the user using the offline content and the corresponding online content. The media server 204 can efficiently associate the bookmarks created by the user while using the offline content and the bookmarks created by the user while using the corresponding online content. Further, the media player 208 can be configured to store the generated URLs into the metadata file 214 corresponding to the offline content. The user can further share the bookmarks URL corresponding to the selected segments of the online and offline content with others users. The other users can directly play or view only the bookmarked content on their respective media players deployed on the devices such as computer, mobile phone, Tablet, desktop, laptop, smart phone, and the like without logging into the online video provider system.

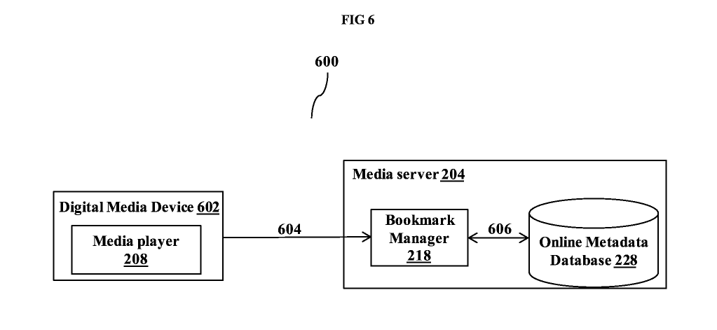

FIG. 6 is a block diagram illustrating generally, operations 600 performed to add bookmark to a segment of an online content from an exemplary digital media device 602, according to the embodiments disclosed herein. The exemplary digital media device 602 described herein can include for example, but not limited to, set top box, digital video recorder, digital data provider, and the like. The media player 208 can be deployed or run on the digital media device 602. In an embodiment, the user can select the starting location/timestamp and end location/timestamp of an interested segment of the online content. At 604, once the user selects the segment, the media player 208 can be configured to transfer the information related to the selected segment to the bookmark manager 218. In an example, the information related to the selected segment includes for example, but not limited to, channel ID, program ID, content ID, digital media device ID, start location/timestamp, end location/timestamp, user name, user ID, and the like. In an embodiment, at 606, the bookmark manger 218 can be configured to store the metadata data of the bookmark information and the bookmark URL into the online metadata database 228.

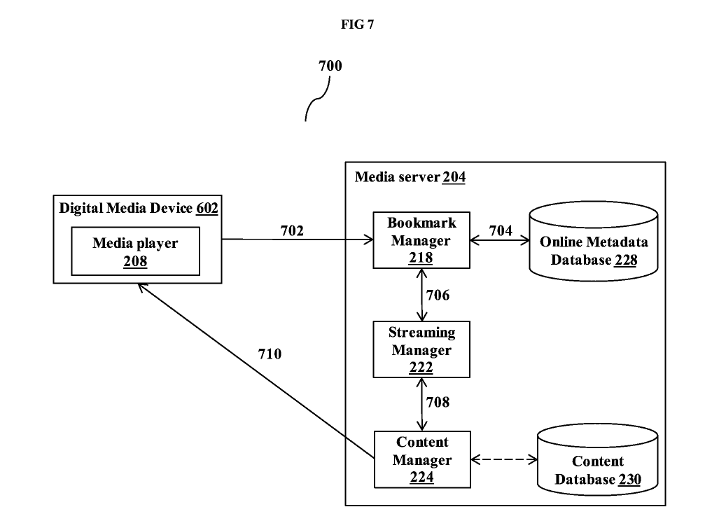

FIG. 7 is a block diagram illustrating generally, operations 700 performed to play the bookmarked segment of the online content on the exemplary media device 602, according to the embodiments disclosed herein. In an embodiment, at 702, when the user opens online content from the media player 208 on the digital media device 602 and selects a bookmark segment of the content, the media player 208 can be configured to send the bookmark ID and digital device ID to the bookmark manager 218.

In an embodiment, at 704, the bookmark manager 218 can be configured to retrieve the bookmark information from the online metadata database 228. In an example, the information related to the selected segment includes for example, but not limited to, channel ID, program ID, content ID, digital media device ID, start location/timestamp, end location/timestamp, user name, user ID, and the like. The bookmark manager 218 can be configured to include sufficient interfaces and programming instructions to retrieve the respective bookmark information. In an embodiment, at 706, the bookmark manager 218 can be configured to send the bookmark information to the streaming manager 222.

In an embodiment, at 708, the streaming manager 222 can be configured to communicate with the content manager 224 to get the desired content from the online content database 230. In an example, the streaming manager 222 can retrieve only the selected segment of the content (instead of entire content) from the online content database 230. In an embodiment, at 710, the streaming manager 222 can be configured to stream the segment of the content on the media player 208 deployed on the digital media device 602. The streaming manager 222 can stream only the selected portion of the content starting from the start location/timestamp of bookmark to till the end location/timestamp of bookmark.

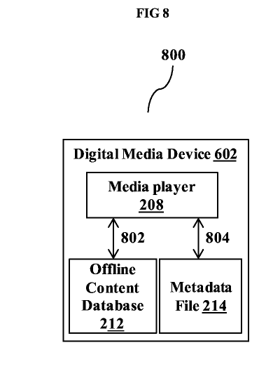

FIG. 8 is a block diagram illustrating generally, operations 800 performed to add and play bookmark a segment of offline content on the exemplary digital media device 602, according to the embodiments disclosed herein. In an embodiment, at 802, the user can play the content offline by storing the online content in the offline content database 212 of the digital media device 602. Upon storing the online content on the computing device 202 for accessing it offline, the digital media device 602 can also store the corresponding metadata file 214 associated with the content.

While playing the content offline, the user can select a starting location/timestamp and an end location/timestamp in the offline content, such as to bookmark the selected segment of the offline content. In an embodiment, at 804, the media player 208 can be configured to write the bookmark information to the respective offline metadata file 214 associated with the offline content. Further, the user can play or view the bookmarked scene on the digital media device 602. The digital media device 602 can be configured to use the metadata information of the bookmark to retrieve only the specific segment of the content from the offline content database 212 and play it using the media player 208. The user can further share the bookmarks corresponding to the selected segments of the offline content with others users. The other users can directly play or view only the bookmarked content on their respective media players deployed on the digital media devices.

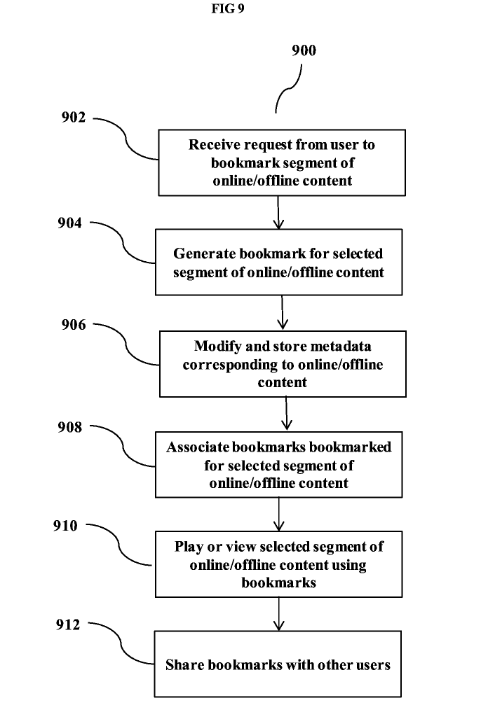

FIG. 9 is a flow diagram illustrating a method 900 for implementing, associating, and sharing bookmarks for segments of online/offline contents, according to the embodiments disclosed herein. In an embodiment, the user can play an online content and store the content on the computing device 202 to play it offline.

In an embodiment, at 902, the method 900 includes receiving a request from a user to bookmark a segment of online or offline content. In an example, while playing the online/offline content (such as an audio, video, or a combination thereof) using the media player 208 (deployed on the computing device 202), the method 900 allows the user to provide the request by selecting an interested segment (or a portion of video) in the online/offline content for bookmarking. The request described herein can include the user selected starting location/time and ending location/time of the online/offline content.

In an embodiment, at 904, the method 900 includes generating bookmark for the selected segment of the online/offline content. In an example, the method 900 allows the media player 208 to transfer the information related to the selected segment of the online/offline to the media server 204. The information related to the selected segment includes for example, but not limited to, content identifier, start location/timestamp, end location/timestamp, user name, user ID, and the like. Further, the method 900 allows the media server 204 to validate the user and generate bookmark URL for the selected segment of the online/offline content.

In an embodiment, at 906, the method 900 includes modifying and storing the metadata corresponding to the online/offline content. In an example, the method 900 allows the media server 204 to store the metadata corresponding to the online content. In an example, if a bookmark for offline content is generated then the method 900 allows the computing device 202 to store the metadata corresponding to the offline content. The metadata described herein can include the bookmark information such as for example, but not limited to, the start location/time of the online/offline content, end location/time of the online/offline content, the user ID, the device ID, and the like.

In an embodiment, at 908, the method 900 includes associate the bookmarks bookmarked for selected segment of online/offline content. In an example, the method 900 allows the media server 204 to dynamically associate the bookmarks bookmarked by the user by using offline content with the online content. The method 900 allows the computing device 202 to share the bookmarks information associated with the offline bookmarks to the media server 204, such as to associate the bookmarks created by the user using the offline content with the online content. The information related to the bookmarks includes for example, but not limited to, bookmark metadata (including start location/timestamp and end location/timestamp of the selected segments of the offline content), content identifier, user name, user ID, and the like. Further, the method 900 allows the media server 204 to efficiently associate (or tie-up) the bookmarks created by the user while using the offline content and the bookmarks created by the same user while using the corresponding online content. The media server 204 can then return the associated bookmark URLs to the computing device 202. The bookmark URL(s) returned to the computing device 202 can include all the bookmarks bookmarked by the user using the offline content and the corresponding online content. Furthermore, the method 900 allows the media player 208 to store the generated URLs into the metadata file 214 corresponding to the online/offline content.

In an embodiment, at 910, the method 900 includes playing or viewing the selected segment of the online/offline content using the bookmarks. In an example, the method 900 allows the user to open the online/offline content using the media player 208 on the computing device 202. In an example, when the user selects the bookmark URL to view an online content, the method 900 allows the computing device 202 to send the send the bookmark URL to the media server 204 to retrieve the bookmark information from the online metadata files and play the content on the computing device 202. In an example, when the user selects the bookmark URL to view the offline content, the method 900 allows the computing device 202 to retrieve the bookmark information from the offline metadata files and play the content on the computing device 202. The method 900 allows the computing device 202 to stream only the selected portion of the online/offline content (as indicated in the bookmark URL) starting from the start location/time of bookmark to till the end location/time of bookmark.

In an embodiment, at 912, the method 900 includes sharing the bookmarks with other users. In an example, the method 900 allows the user to share the bookmarks URL corresponding to the selected segments of the online and offline content with others users. The other users can directly play or view only the bookmarked content on their respective media players without login into the content provider system.

The various actions, operations, steps, blocks, units, or acts described with respect to the FIGS. 3 through 9 can be performed in sequential order, in random order, simultaneously, parallel, or a combination thereof. Further, in some embodiments, some of the actions, operations, steps, blocks, units, or acts can be omitted, skipped, modified, or added without departing from the scope of the Embodiments.

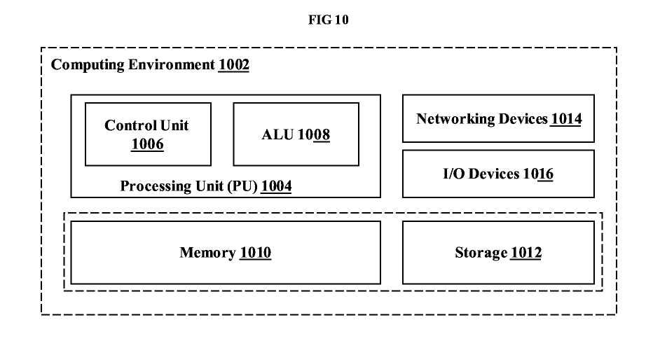

FIG. 10 illustrates a computing environment 1002 implementing the method and systems as disclosed in the embodiments herein. As depicted the computing environment 1002 comprises at least one processing unit 1004 that is equipped with a control unit 1006 and an Arithmetic Logic Unit (ALU) 1008, a memory 1010, a storage unit 1012, plurality of networking devices 1014 and a plurality Input output (I/O) devices 1016. The processing unit 1004 is responsible for processing the instructions of the algorithm. The processing unit 1004 receives commands from the control unit 1006 in order to perform its processing. Further, any logical and arithmetic operations involved in the execution of the instructions are computed with the help of the ALU 1008.

The overall computing environment 1002 can be composed of multiple homogeneous and/or heterogeneous cores, multiple CPUs of different kinds, special media and other accelerators. The processing unit 1004 is responsible for processing the instructions of the algorithm. Further, the plurality of processing units 1004 may be located on a single chip or over multiple chips.

The algorithm comprising of instructions and codes required for the implementation are stored in either the memory unit 1010 or the storage 1012 or both. At the time of execution, the instructions may be fetched from the corresponding memory 1010 and/or storage 1012, and executed by the processing unit 1004.

In case of any hardware implementations various networking devices 1014 or external I/O devices 1016 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 through 10 include blocks, steps, operations, units, modules, and acts, which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for bookmarking and dynamically associating bookmarks of offline content with online content, the method comprising:
receiving at least one request from a user to bookmark at least one segment of content, wherein said content is at least one of online content and offline content;
generating at least one bookmark for said at least one segment of said content;
associating said at least one bookmark for said at least one segment of said content bookmarked by said user; and
playing said at least one segment of said content using said at least one bookmark.

2. The method of claim 1, wherein said content comprises audio and video content.

3. The method of claim 1, wherein said method further comprises storing said online content to access offline by said user.

4. The method of claim 1, wherein said method further comprises registering said user to allow access to said online and offline content.

5. The method of claim 1, wherein said request comprises at least one of starting location and ending location of said segment of said content.

6. The method of claim 1, wherein said bookmark comprises a uniform resource locater for said segment of said content.

7. The method of claim 1, wherein said method further comprises maintaining a metadata associated with said content.

8. The method of claim 7, wherein said method further comprises updating said metadata upon receiving said request from said user to bookmark said at least one segment of said content.

9. The method of claim 1, wherein said method further comprises authenticating said user upon receiving said request to bookmark said at least one segment of said content

10. The method of claim 1, wherein said method further comprises sharing said bookmarks with at least one other user.

11. The method of claim 1, wherein said method further comprises allowing said at least one other user to play said at least one segment of said content using said at least one bookmark.

12. A system for bookmarking and dynamically associating bookmarks of offline content with online content, the system comprising a media server configured to:
receive at least one request from a user to bookmark at least one segment of content, wherein said content is at least one of online content and offline content,
generate at least one bookmark for said at least one segment of said content,
associate said at least one bookmark for said at least one segment of said content bookmarked by said user, and
play said at least one segment of said content using said at least one bookmark.

13. The system of claim 12, wherein said content comprises audio and video content.

14. The system of claim 12, wherein said system of claim 12, wherein said media server is further configured to store said online content to access offline by said user.

15. The system of claim 12, wherein said media server is further configured to register said user to allow access to said online and said offline content.

16. The system of claim 12, wherein said request comprises at least one of starting location and ending location of said segment of said content.

17. The system of claim 12, wherein said bookmark comprises a uniform resource locater for said segment of said content.

18. The system of claim 12, wherein said media server is further configured to maintain a metadata associated with said content.

19. The system of claim 12, wherein said media server is further configured to update said metadata upon receiving said request from said user to bookmark said at least one segment of said content.

20. The system of claim 12, wherein said media server is further configured to authenticate said user upon receiving said request to bookmark said at least one segment of said content

21. The system of claim 12, wherein said media server is further configured to share said bookmarks with at least one other user.

22. The system of claim 12, wherein said media server is further configured to allow said at least one other user to play said at least one segment of said content using said at least one bookmark.

23. A computer program product for bookmarking and dynamically associating bookmarks of offline content with online content, the product comprising:
an integrated circuit comprising at least one processor;
at least one memory having a computer program code within said circuit, wherein said at least one memory and said computer program code with said at least one processor cause said product to:
receive at least one request from a user to bookmark at least one segment of content, wherein said content is at least one of online content and offline content,
generate at least one bookmark for said at least one segment of said content,
associate said at least one bookmark for said at least one segment of said content bookmarked by said user, and
play said at least one segment of said content using said at least one bookmark.
